(19) United States
(12) Patent Application Publication
(10) Pub. No.: US 2004/0043274 A1
(43) Pub. Date: Mar. 4, 2004

(54) Fuel cell power system

(76) Inventors: John P. Scartozzi, Spokane, WA (US); Peter D. DeVries, Spokane, WA (US)

Correspondence Address: WELLS ST. JOHN P.S., 601 W. FIRST AVENUE, SUITE 1300, SPOKANE, WA, 99201, US

(21) Appl. No.: 09/873,139

(22) Filed: Jun. 1, 2001

(51) Int. Cl. H01M 8/24; H01M 8/04

(52) U.S. Cl. 429/34; 429/26; 429/38

(57) ABSTRACT

A fuel cell power system is described and which includes a plurality of modules each enclosing a fuel cell stack and a cooling system, and wherein at least one of the modules can be easily removed from the fuel cell power system, by hand, while the remaining modules continue to operate.

### TECHNICAL FIELD

The present invention relates to a fuel cell power system, and more specifically to a fuel cell power system which employs fuel cell modules which enclose fuel cell stacks.

### BACKGROUND OF THE INVENTION

The fuel cell is an electrochemical device which reacts hydrogen; and oxygen, which is usually supplied from the air, to produce electricity and water. Heretofore, fuel cells have utilized a wide range of fuels, including, but not limited to, natural gas and coal derived synthetic fuels, and which are subsequently converted to electric power. The basic process is well understood, highly efficient, and for those fuel cells fueled directly by hydrogen, pollution free. Further, since fuel cells can be assembled into stacks of varying sizes, power systems have been developed to produce a wide range of output levels to satisfy numerous applications.

Although the fundamental electrochemical processes involved in all fuel cells are well understood, engineering solutions have proved elusive for making fuel cell stack arrangements commercially feasible, and economical. In the case of fuel cell stacks which use proton exchange membranes, reliability has not been the driving concern to date, but rather the installed cost per watt of generation capacity has. With respect to these types of fuel cells, in order to lower the fuel cost per watt, much attention has been placed on increasing power output. In the elusive search to increase power output, much research and development activity has been spent on additional, and often sophisticated balance-of-plant measures. These previous balance-of-plant measures or systems have been deemed necessary to optimize and maintain the high fuel cell power outputs desired. As a direct result of these additional balance-of-plant measures these fuel cell systems do not readily scale down to low generation capacities. Consequently, the installed cost; efficiency; reliability and maintenance expenses are all adversely affected in low generation applications. Yet further, since proton exchange membrane fuel cells produce a useful voltage of only about 0.5 to about 0.7 volts D.C. under a load, practical fuel cell plants have been built from multiple cells stacked together such that they are electrically connected in series. In order to reduce the number of parts and to minimize costs, rigid supporting/conducting separator plates, often fabricated from graphite or special metals have been utilized. This is often described as bipolar construction. Heretofore, practical stacks have consisted of 20 or more cells in order to produce the direct current voltages necessary for efficient inverting to alternating current.

While the economic advantages of stack designs using bipolar plate construction are compelling, this construction does have numerous disadvantages which have detracted from its usefulness. For example, if the voltage or performance of a single cell in a stack begins to decline or fails, the entire stack, which is held together in compression with tie bolts, must be taken out of service, disassembled and repaired. In traditional fuel cell stack designs, the fuel and oxygen are directed by means of internal manifolds to the proper electrodes. Cooling for the stack is provided either by the reactants; natural convection; radiation; and possibly supplemental cooling plates. Also included in the prior art stack designs are cell-to-cell seals; insulation; piping and various instrumentation and sensors for use in monitoring the fuel cell performance. As should be apparent, if malfunction or a maintenance problem occurs with a fuel cell stack design, there is no ready solution except to take the fuel cell stack off-line and return it to the factory for repair or replacement as necessary. In view of the difficulties encountered in removing fuel cell stacks of this type for repair or replacement, such designs have not become practical from a commercial sense, at least as applied to low generation applications.

A new fuel cell power system utilizing fuel cell stack technology which avoids the perceived shortcomings of the prior art is the subject matter of the present invention.

### SUMMARY OF THE INVENTION

One aspect of the present invention is to provide a fuel cell power system which includes a plurality of modules, each enclosing a fuel cell stack, and a cooling assembly, and wherein at least one of the modules can be removed from the fuel cell power system, by hand, while the remaining modules continue to operate.

Another aspect of the present invention is to provide a fuel cell power system which includes an enclosure defining an internal space; a subrack moveably mounted on the enclosure and operable to be received in the internal space defined by the enclosure; and a plurality of modules each enclosing a fuel cell stack, and wherein the modules operably mate with the subrack, and can be removed from the subrack while the remaining modules continue to operate.

Yet another aspect of the present invention relates to a fuel cell power module which includes a module frame having an internal cavity; a fuel cell stack mounted in the internal cavity of the module frame; a controller electrically coupled to the fuel cell stack; and a cooling assembly borne by the module frame and electrically coupled with the controller for dissipating heat energy generated while the fuel cell stack is operational.

Moreover another aspect of the present invention relates to a fuel cell power system which includes a subrack; a D.C. bus mounted on the subrack; a fuel and oxidant manifold borne by the subrack; a module frame defining an internal cavity, and which is matingly received and supported in an operable orientation on the subrack; an electrical coupler borne by the module frame and which releasably electrically couples with the D.C. bus when the module frame is disposed in an operable orientation relative to the subrack; a fluid coupler borne by the module frame, and which releasably couples, in fluid flowing relation, with the fuel and oxidant manifold when the module frame is disposed in an operable orientation relative to the subrack; a fuel cell stack mounted in the internal cavity of the module frame, and which is electrically coupled with both the electrical coupler and the D.C. bus, and is further disposed in fluid flowing relation relative to the fuel and oxidant manifold when the module frame is disposed in an operable orientation relative to the subrack, and wherein the fuel cell stack produces heat energy during operation; a cooling assembly borne by the module frame, and which dissipates the heat energy generated by the fuel cell stack during operation; and a controller which is electrically coupled with both the fuel cell stack and the cooling assembly to control the operation of each.

Still another aspect of the present invention relates to a fuel cell power system which includes an enclosure having a cavity, and which further has a data conduit; a power conduit; and fuel and oxygen delivery conduits mounted on same; multiple subracks releasably borne by the enclosure and disposed in an operable orientation in the cavity; a D.C. bus mounted on each of the subracks and which is electrically coupled to the power conduit when the respective subracks are received in the cavity of the enclosure; a fuel and oxidant manifold mounted on each of the subracks and which is coupled in fluid flowing relation relative to the fuel and oxygen delivery conduits when the respective subracks are received in the cavity of the enclosure; multiple fuel cell modules operably received and supported by the respective subracks, and wherein each of the fuel cell modules have a module frame, defining an internal cavity, and which is matingly received and supported in an operable orientation on the respective subracks; an electrical coupler borne by each of the module frames, and which releasably electrically couples with the D.C. bus when the individual module frames are disposed in an operable orientation relative to one of the subracks; a fluid coupler mounted on each of the module frames and which releasably couples in fluid flowing relationship with the fuel and oxidant manifold when the module frame is disposed in an operable orientation relative to one of the subracks; a fuel cell stack mounted in the internal cavity of each of the module frames, and which is electrically coupled with both the electrical coupler, and the D.C. bus, and further disposed in fluid flowing relation relative to the fuel and oxidant manifold when the modular frame is disposed in an operable orientation relative to one of the subracks, and wherein each fuel cell stack produces heat energy during operation; a cooling assembly borne by each of the module frames, and which dissipates the heat energy generated by each of the fuel cell stacks during operation; and a controller which is electrically coupled with both the fuel cell stack and the cooling assembly of that fuel cell module to control the operation of each, and wherein the controller is coupled in signal transmitting and receiving relation relative to the data conduit, and wherein the individual subracks and individual fuel cell modules may be operably removed while the remaining fuel cell modules and subracks remain operational.

### DETAILED DESCRIPTION OF THE DRAWINGS

The accompanying drawings serve to explain the principles of the present invention.

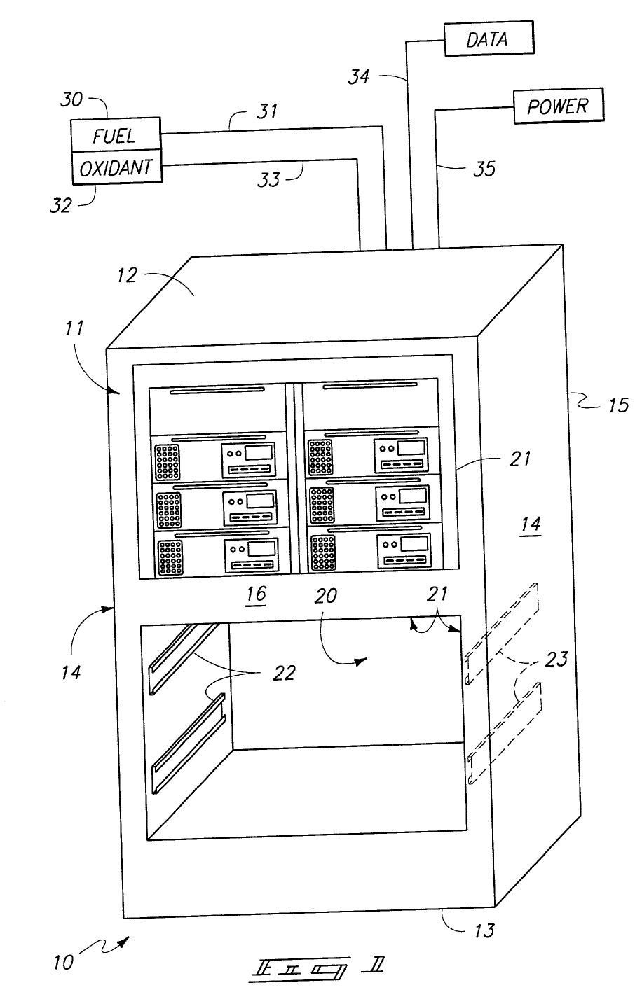

FIG. 1 is a front elevation view of a fuel cell power system of the present invention.

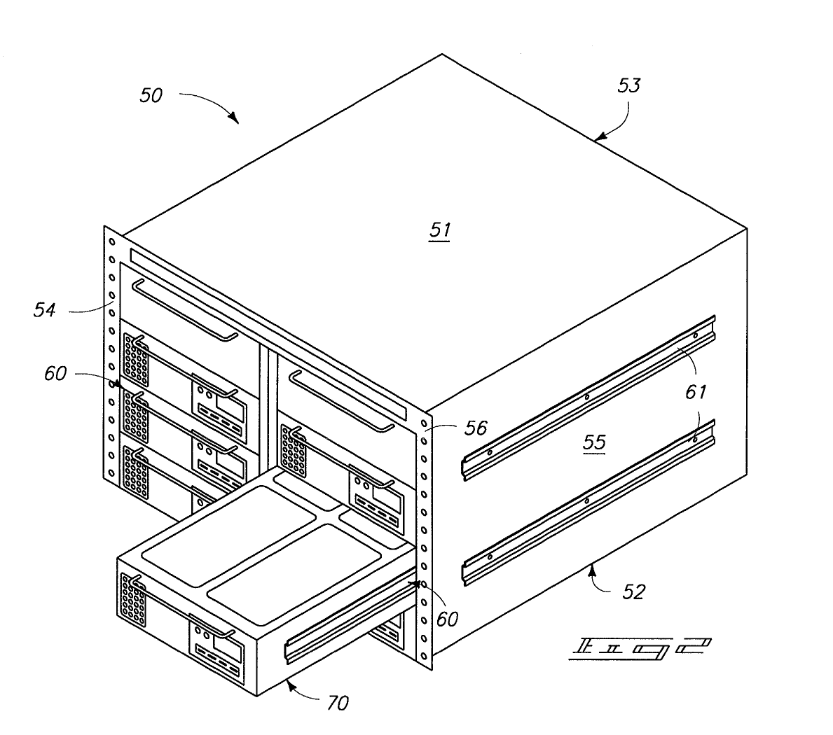

FIG. 2 is a perspective view of the subrack employed with the present invention, and showing a portion of a fuel cell module which is enclosed within same.

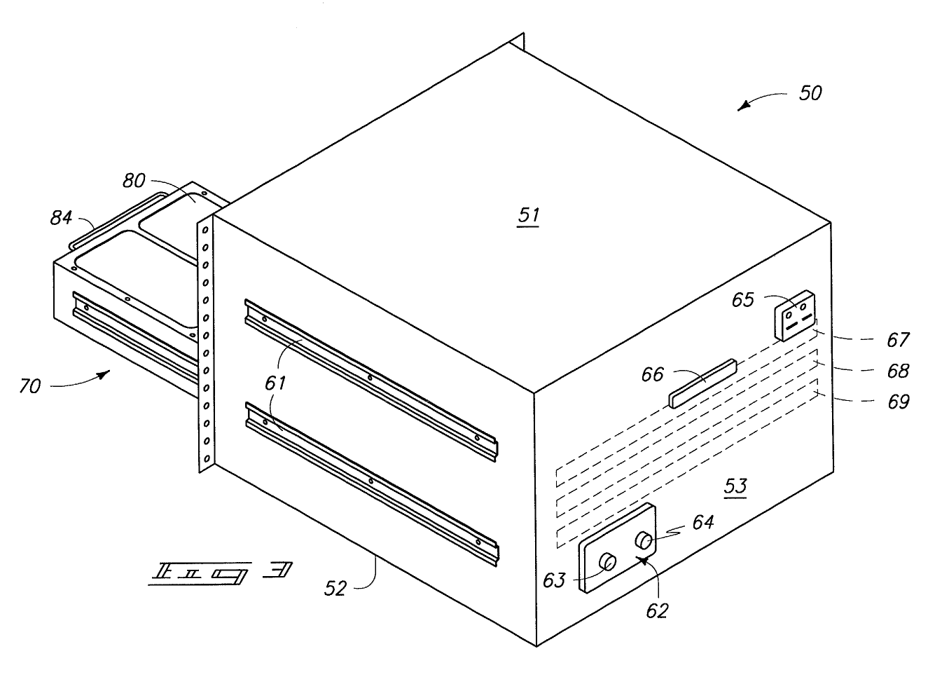

FIG. 3 is a perspective, rear elevation view of FIG. 2.

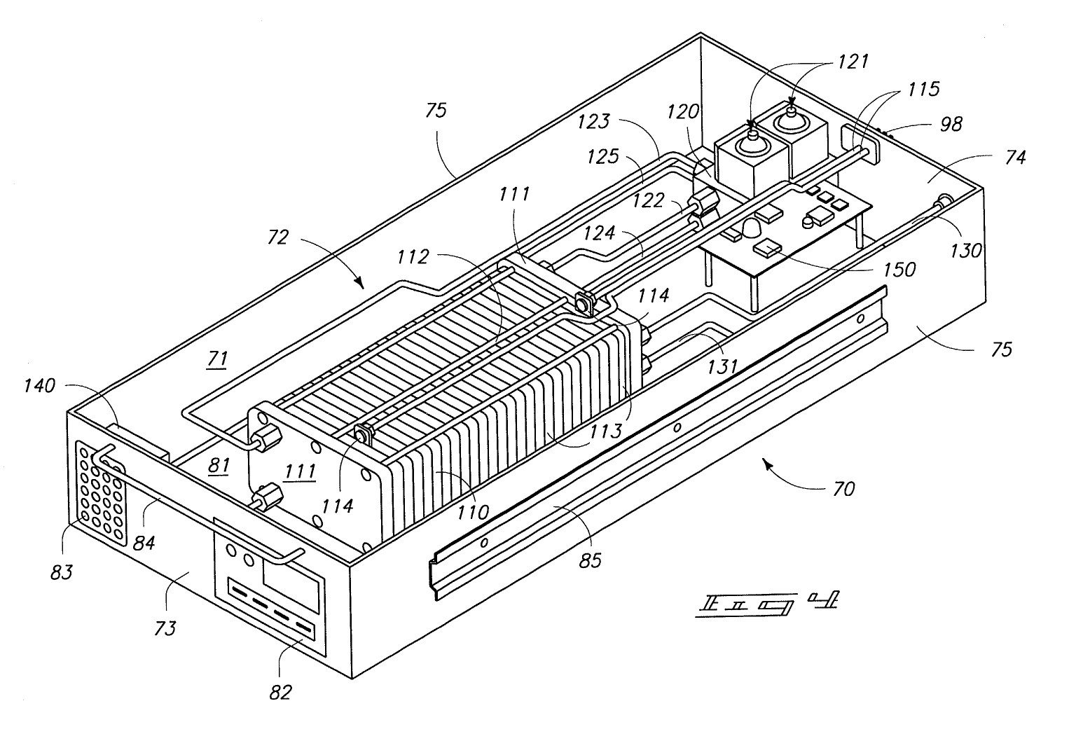

FIG. 4 is a perspective, plan view of a first form of the fuel cell module employed in the fuel cell power system of the present invention with the top surface removed to show the structure thereunder.

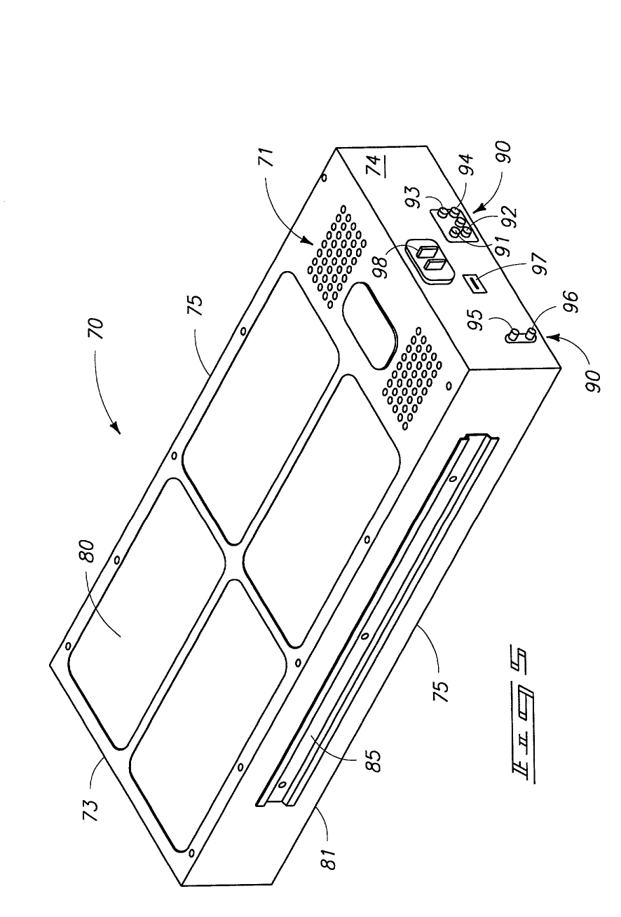

FIG. 5 is a perspective, rear elevation view of the structure shown in FIG. 4.

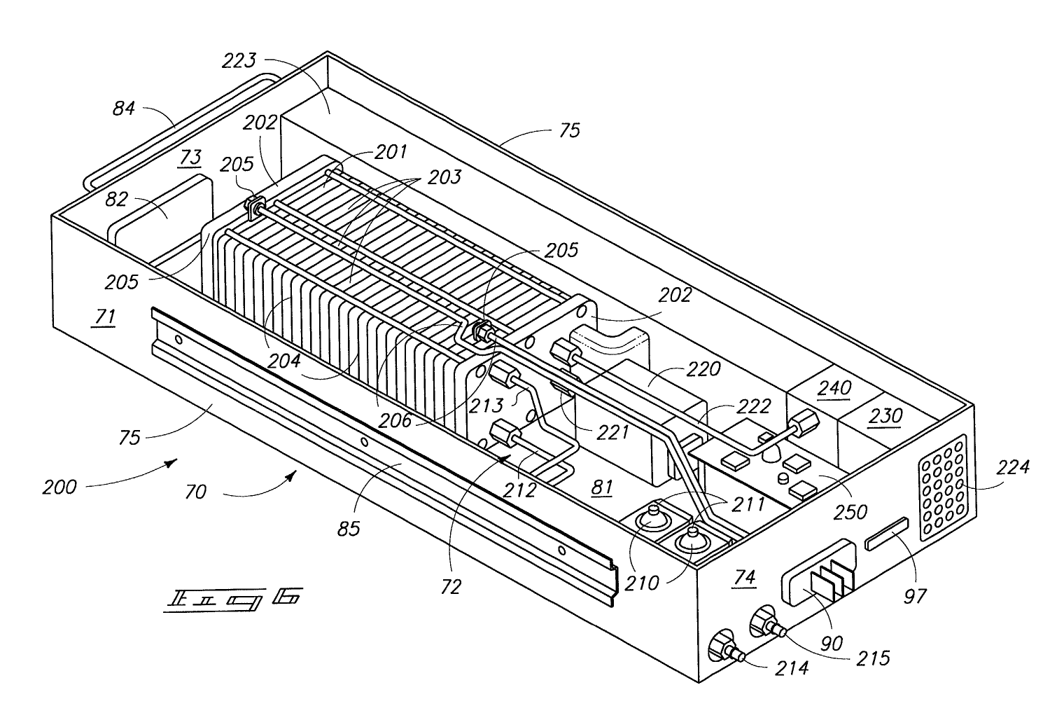

FIG. 6 is a perspective, rear elevation view of a second form of the fuel cell module employed with the fuel cell power system of the present invention with the top surface removed to show the structure thereunder.

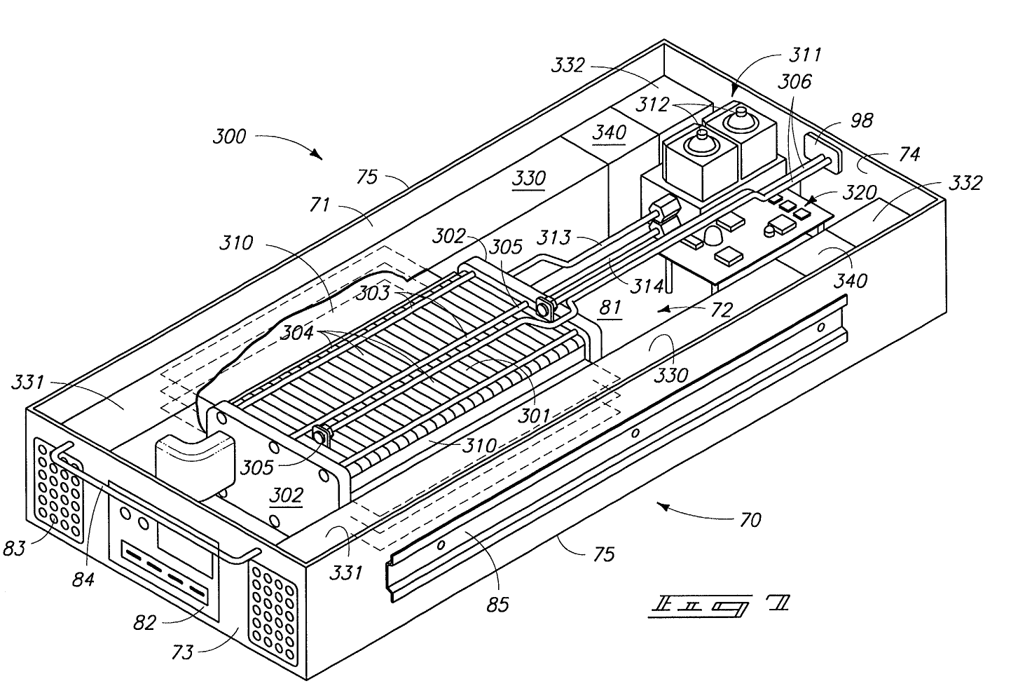

FIG. 7 is a perspective, front elevation view of a third form of the fuel cell module used with the fuel cell power system of the present invention. The top surface has been removed to show the structure thereunder.

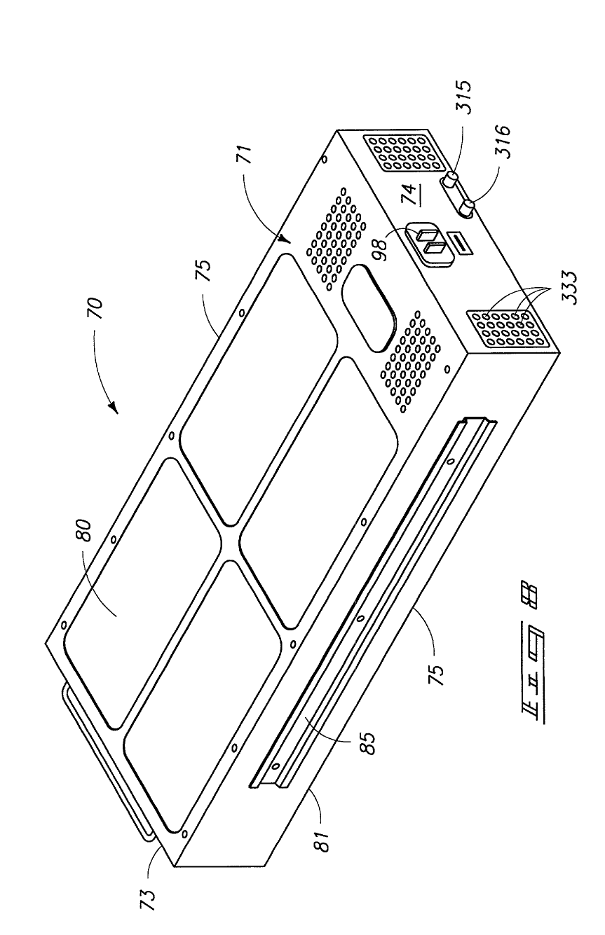

FIG. 8 is a rear elevation view of the structure shown FIG. 7.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

The fuel cell power system is generally indicated by the numeral 10 in FIG. 1. As shown therein, the fuel cell power system 10 includes an enclosure or housing which is generally indicated by the numeral 11. The enclosure is defined by a top surface 12; bottom surface 13; opposite side walls 14; a rear wall 15; and a front wall 16, all of which defines a generally rigid enclosure. An internal cavity 20 is defined by the surfaces or walls 12-16, respectively. As seen in FIG. 1, a pair of subrack apertures 21 are formed in, and are defined by the front wall 16, and are operable to allow the passage of the respective subracks therethrough. These subracks will be discussed in greater detail hereinafter. As seen in FIG. 1, a first pair of rails 22; and a second pair of rails 23; are individually mounted within the cavity 20 and are oriented in generally horizontal, spaced, parallel relation one to the other. The respective pairs of rails are operable to slidably mate, couple, or otherwise mechanically cooperate with corresponding mating rail structures which are mounted on the subrack, which will be discussed hereinafter, to permit the subrack to be slidably or moveably received through one of the apertures 21 and then located in an operable orientation within the cavity 20 of the enclosure 11.

The enclosure or housing 11 is supplied with a fuel supply which is generally indicated by the numeral 30. This fuel supply may come from numerous sources. For example, the fuel supply may comprise bottled hydrogen, or a fuel which is supplied by way of a fuel processor. The fuel may also comprise a hydrogen rich gas. For purposes of further discussion in this application however, it will be assumed that the fuel supply 30 comprises hydrogen, or a hydrogen rich gas, which may have been generated by means of a fuel processor. A fuel supply conduit 31 is coupled in fluid flowing relation relative to the fuel supply 30 and terminates inside of the enclosure 11 by way of a suitable releasably sealable fluid coupling. Similarly, a suitable oxidant supply 32 is provided, and is coupled in fluid flowing relation relative to the enclosure 11 by means of an oxidant supply conduit 33. This oxidant supply conduit similarly terminates with an appropriate releasably sealable fluid coupling. The oxidant supply 32 may constitute air; although, depending upon the type of fuel cell employed, it may also include other gasses. If air is the oxidant for the fuel cell, in one form of the invention, the oxidant supply conduit, may not be required. This will be discussed in greater detail hereinafter. As seen in FIG. 1 a data conduit 34 is provided, and which terminates in the cavity 20 of the enclosure 11. The data conduit 34 allows the transmission of electrical signals (data) to and from the apparatus 10. These electrical signals permit, in some forms of the invention, the control; and monitoring of the performance of the fuel cell power system 10. Yet further, a power conduit 35 is borne by the enclosure 11, and terminates within the cavity 20. The power cable or conduit 35 is operable to direct electrical power generated by the fuel cell power system 10 away from the enclosure 11 and to a remote location. The electrical power generated by the apparatus 10 may include D.C. power; or A.C. power, in the event that the fuel cell power system includes an inverter for converting the D.C. to A.C..

Referring now to FIG. 2 a fuel cell module subrack is generally indicated by the numeral 50. As seen therein, the module subrack 50 is defined by top and bottom surfaces 51 and 52; a rear surface 53; a front surface 54; and opposite sidewalls 55. An engagement flange 56 is affixed substantially along the peripheral edge of the front surface 54, and is operable to engage the front wall 16 of the enclosure 11 when the module subrack 50 is fully received or seated in an operable position or orientation relative to the enclosure 11. Module apertures 60 are formed in the front surface 54, and are operable to matingly receive and allow the passage of the respective fuel cell modules, which will be discussed hereinafter. As seen in FIG. 2, a pair of rail guides 61 are attached or mounted on each of the opposite sides 55 (only one pair shown). The respective pairs of rail guides 61 slidably and otherwise cooperatively mate with the first and second pair of rail guides 22 and 23 which are mounted in the cavity 20 of the enclosure 11, as seen in FIG. 1. In this arrangement the individual module subracks 50 can move reciprocally relative to the cavity 20 of the enclosure 11. This arrangement also allows the respective modular subracks 50 to be easily repaired, replaced, or inspected in the event of poor performance or failure, while the remaining modular subracks continue to operate.

As seen in FIG. 3, a pair of fluid couplings, which are generally indicated by the numeral 62, are mounted at predetermined locations on the rear surface 53. The respective fluid couplings 62 include a fuel coupler 63; and an oxidant coupler 64, both of which extend through the rear surface 53. The fuel and oxidant couplers 63 and 64 are coupled in releasable, fluid flowing relation relative to the respective fuel and oxidant supply lines 31 and 32 which terminate within the cavity 20 of the enclosure 11, and which were discussed above. Yet further, a power coupler 65 and a data coupler 66 are also provided. These power and data couplers similarly correspondingly releasably mate or electrically couple with the power conduit 35; and the data conduit 34, both of which terminate within the cavity 20 of the enclosure 11. As seen in FIG. 3, in phantom lines, a D.C. Bus 67 is provided and which is mounted internally of the subrack 50. Yet further a fuel/oxidant manifold 68 is also provided and is mounted in spaced, relation relative to the D.C. Bus 67. A data bus 69 is also mounted internally of the subrack 50 for the purposes which will be discussed below. As will be appreciated from a study of FIG. 3, the individual fuel cell modular subracks 50 can be easily and rapidly detached and removed from the enclosure 11 without need of special tools, and most importantly by hand. Yet further, and in another form of the invention, the subrack 50 may include an inverter (not shown) for converting D.C. to A.C.

### FIRST FORM

Referring now to FIGS. 4 and 5, where the first form of the invention is seen, the fuel cell power system 10 of the present invention includes a plurality of fuel cell modules 70, each enclosing a fuel cell stack, which will be discussed hereinafter, and wherein at least one of the fuel cell modules 70 can be removed from the fuel cell power system 10, by hand, while the remaining fuel cell modules continue to operate. As seen in FIGS. 4 and 5, each of the fuel cell power modules 70 comprise a module frame which is generally indicated by the numeral 71. The module frame defines an internal cavity 72 which encloses the operable components or elements which will be discussed below. The module frame 71 includes a front wall 73; a rear wall 74, which is spaced from the front wall 73; and opposite side walls 75, which form a generally narrowly rectangular shape. Of course, other enclosure shapes may be employed with equal success. The module frame further has a top surface 80 and a bottom surface 81. As seen in FIG. 4 a control or status panel 82 which displays several of the operational conditions of the fuel cell module 70 is mounted on or affixed to the front wall 73. The control or status panel may have various warning lights; alpha-numeric indicators; visually perceptible digital or analog controls of various types and assorted switches which control or display various aspects of the operation or condition of the fuel cell module 70. Still further, and as seen in FIG. 4 an air passageway 83 is formed through, or defined by the front wall 73. This air passageway allows ambient air to pass into, and through the internal cavity 72 for the purposes which will be discussed in greater detail below. Also seen in FIG. 4, is a handle 84 which is attached to the front wall 73, and a pair of rail guides 85 which are individually mounted on the opposite sidewalls 75. It should be understood that these rail guides 85 matingly couple or mechanically cooperate with other rail guide assemblies (not shown) which are mounted internally of the fuel cell module subrack 50. Such can be understood from a study of FIG. 2. As will be appreciated, the pair of rail guides 85 permit the fuel cell module 70 to be easily removed, by hand, from the subrack 50 for purposes of maintenance, repair, or replacement depending upon the operational needs or conditions.

Referring now to FIG. 5, it will be seen that a plurality of fluid couplers 90 are mounted on the rear wall 74 of the module frame 71. In this regard the respective fluid couplers 90 include a fuel or hydrogen feed or delivery coupler 91; an air or oxidant feed or delivery coupler 92; a fuel or hydrogen return or bleed coupler 93; an air or oxidant return or bleed coupler 94; a coolant feed or delivery coupler 95; and a coolant return coupler 96. Yet further, the rear wall 74 further includes a releasably engageable data coupler 97, and an electrical coupler 98. It should be understood that the respective fluid couplers 90 appropriately mate or otherwise cooperate with the fuel/oxidant manifold 68 such that they are disposed in fluid flowing relation relative thereto. Similarly, the D.C. electrical bus 67 electrically couples with the electrical coupler 98. Yet further, the data coupler 97 releasably electrically couples in signal transmitting and receiving relation relative to the data bus 69.

Referring still to FIG. 4, the fuel cell power module 70 further includes a fuel cell stack which is generally indicated by the numeral 110. The fuel cell stack 110 is received in the internal cavity 72, and is operable to produce electricity when supplied with a suitable fuel 30 and an oxidant 32 as discussed above. The fuel cell stack, as shown, is of a traditional design, that is, It has opposite end plates which are generally indicated by the numeral 111, and which are pulled or urged, one towards the other, by a plurality of tie bolts which are generally indicated by the numeral 112. The respective tie bolts place a plurality of proton exchange fuel cell membranes 113, and other assemblies, such as bipolar plates (not shown), into compression, such that a pair of spaced current collectors 114 may receive and collect the electrical current that is generated by each of the fuel cell membranes 13. Yet further, the stack may have a monopolar structure which employs fuel cell membranes that are fabricated in a strip cell arrangement. As seen in FIG. 4, a pair of electrical conduits 115 respectfully electrically connect or couple the individual current collectors 114 with the electrical coupler 98. As seen further in FIG. 4, a fuel/air or oxidant delivery and bleed manifold 120 is mounted within the internal cavity 72 of the module frame 71. The fuel/air or oxidant delivery and bleed manifold 120 is coupled in fluid flowing relation with the respective fluid couplers 91-94 respectively. The fuel/air delivery and bleed manifold 120 further includes a pair of adjustable valve or metering assemblies 120 which are made integral therewith. The respective valve assemblies control the flow of gases along the individual air delivery and return conduits 122 and 123, respectively; and the fuel delivery and return conduits 124 and 125 respectively. The air delivery and air return conduits 122 and 123 couple the fuel cell stack 120 in fluid flowing relation with a suitable oxidant supply such as air or oxygen 32. The fuel delivery and fuel return conduits 124 and 125 couple the fuel cell stack in fluid flowing relation relative to a suitable fuel supply which may comprise a source of hydrogen 30 or a hydrogen rich gas, as earlier discussed. This is of course, providing that the fuel cell stack 110 takes on the form of a proton exchange membrane fuel cell stack.

As further seen in FIG. 4, the fuel stack 110 is coupled to individual coolant delivery and return conduits 130 and 131 respectively. As seen in the drawings, the coolant delivery and return conduits 130 and 131 are individually coupled in fluid flowing relation with the coolant feed and coolant return couplers 95 and 96, respectively. Still further a cooling assembly, such as a fan 140 is mounted in air moving relation relative to the air passageway 83. The fan is electrically coupled with, and controlled by, an electronic control assembly which is generally indicated by the numeral 150. The electronic control assembly 150 is electrically coupled with the data coupler 97, and is mounted in spaced relation relative to the bottom surface 81 as shown. The electronic control assembly 150 is further electrically coupled with the control or status display panel 82 which shows the current operational state of the fuel cell power module 70. It should be recognized that the electronic control assembly may be located remotely relative to the fuel cell power module 70. For example, it may be located on the fuel cell subrack 50; the enclosure 11; or at a distant location away from the fuel cell power system 10. It should be understood that the cooling assembly or fan 140 is selectively energized such that heat energy generated by the fuel cell stack 110, during operation, and which is captured within the internal cavity 72, may be exhausted to ambient. Cooling of the fuel stack, as will be recognized, is achieved by the circulation of a coolant through the conduits 130, and 131. Additionally, it should be understood that the individual fuel cell modules may also enclose an inverter (not shown) for converting D.C. to A.C. or D.C. to D.C.

### SECOND FORM

Referring now to the second form of the invention 200 which is shown at FIG. 6, this form of the invention 200 has many of the features of the first form of the invention and therefore for purposes of brevity are not repeated herein. It should be understood that common elements bear similar numbers. The second form 200 includes a fuel cell stack 201 of similar design to that which was previously discussed. For example, this particular fuel cell stack has end-plates 202 which are held together by a plurality of tie-bolts 203. The tie-bolts draw or urge the end-plates together thereby placing a plurality of proton exchange fuel cell membranes 204, and other assemblies, into compression. As was the case with the first form of the invention shown in FIG. 4, a pair of current collectors 205 are provided and which are disposed in spaced relationship one to the other. As discussed earlier, the pair of current collectors 205 are operable to collect electrical current that is generated by the respective proton exchange fuel cell membranes 204. Still further, and as was the case with the first form of the invention, a pair of electrical conduits or conductors 206 electrically couple the respective pair of current collectors 205 to the electrical coupler 98 which is mounted on the rear wall 74. As seen from a study of FIG. 6 a fuel and air or oxidant delivery/bleed manifold 210 is provided. The manifold 210 further includes a pair of valve assemblies 211 of similar construction to that which was previously disclosed, and which is operable to meter a source of fuel 30 or oxidant 32 to the fuel cell stack 201. The fuel and air or oxidant delivery manifold 210 is coupled in fluid flowing relation relative to the fuel cell stack 201 by fuel and oxidant delivery conduits 212 and 213 respectively. As was the case with the first form 70 of the invention shown in FIG. 4, the fuel/air or oxidant delivery and bleed manifold 210 is coupled in fluid flowing relation to respective fuel 214 and oxidant couplers 215 which are affixed on the rear wall 74.

The second form of the invention 200 also includes a coolant pump and accumulator which is generally designated by the numeral 220. The coolant pump and accumulator 220 includes a source of coolant, not shown, and which is recirculated by means of the coolant pump portion to the fuel cell stack 201. The coolant pump and accumulator 220 is coupled in fluid flowing relation relative to the fuel cell stack 201 by coolant delivery and coolant return conduits which are generally indicated by the numerals 221 and 222 respectively. The present form of the invention also includes an air passageway or plenum 223 and which extends between the forward facing and rearward facing walls 73 and 74 of the module frame 70. As seen in FIG. 6, a plurality of apertures 224 are formed in the rear wall 74 and are generally coaxially aligned with the air passageway 223. These apertures facilitate the coupling of the air passage 223 to ambient. Disposed intermediate the opposite ends of the air passageway 223 is a fan and heat exchanger which are generally indicated by the numerals 230, and 240 respectively. The heat exchanger 240 is coupled in fluid flowing relation relative to the coolant return conduit 222. In this arrangement, heat energy which is generated during the operation of the fuel cell stack 201 can be imparted to the coolant and thereafter to the heat exchanger 240. The fan 230 is operable to move a substantially steady supply of ambient air through the air passageway 223 and past the heat exchanger 224 for purposes of eliminating heat energy generated by the fuel cell power module 70. The present form of the invention also has an electronic control assembly 250 which is similar to the first form of the invention. The assembly 250 is coupled in controlling relation relative to the coolant pump and accumulator 220; the fan 230; heat exchanger 240; and the control or status panel 82. The electronic control assembly is further electrically coupled with the data coupler 97. As was the case with the other forms of the invention, previously disclosed, the assembly 250 may be positioned remotely relative to the fuel cell module 70. Also, this form of the invention could include an inverter for converting D.C. to A.C. or D.C. to D.C.

### THIRD FORM

The third form of the invention is generally indicated by the numeral 300, and is best seen in FIGS. 7 and 8, respectively. The third form of the invention is similar, in some respects, to the first and second forms of the invention disclosed above. In this regard, the third form of the invention 300 has a fuel cell stack 301 of similar design to the first and second forms of the invention. For example, the third form of the invention 300 includes opposite endplates 302 which are drawn or urged one towards the other by a plurality of tie-bolts 303. As discussed earlier, the tie-bolts place a plurality of proton exchange fuel cell membranes 304, and other assemblies, into compression. Similarly, a pair of opposite current collectors 305 are provided to collect the D.C. electrical current which is generated by the fuel cell stack 301 during operation. The current collectors are electrically coupled to the electrical coupler 98 by a pair of electrical conduits which are generally indicated by the numeral 306. In this particular form of the invention the fuel cell stack 301 also includes a plurality of heat exchangers which are made integral with the fuel cell stack and which extend substantially laterally outwardly relative thereto. The heat exchangers are operable to conduct heat energy generated by the fuel cell stack 301 away from same. In an alternative form of the invention the fuel cell stack 301 may be reconfigured such that ambient air may be moved in and through, the fuel cell stack for purposes of cooling the fuel cell stack and simultaneously supplying the needed oxidant.

In the third form of the invention 300 the present invention also includes a fuel/air or oxidant delivery and bleed manifold 311 of similar construction to that which was earlier described in the first and second forms of the invention. This manifold 311 includes a pair of valve assemblies 312 which are operable to selectively meter the fuel 30 and the oxidant 31 which is delivered by way of the fuel delivery conduit 313, and oxidant delivery conduit 314 to the fuel cell stack 301. The fuel and oxidant delivery conduits 313 and 314 are coupled in fluid flowing relation with the respective fuel 315 and oxidant couplers 316 which are mounted on the rear wall 74. The present form of the invention 300 further includes an electronic control assembly 320 of similar design to that earlier disclosed, and which is electrically coupled in controlling relation relative to such assemblies as the control or status panel 82; the fuel/air or oxidant delivery and bleed manifold 311; and the individual valves 312 which are made integral therewith. As with other forms of the invention the electronic control assembly may be remotely located relative to the fuel cell module 70.

In the third form of the invention, a pair of air plenums or passageways 330 are provided, and which extend therebetween the forward facing wall 73, and the rearward facing wall 74 of the module frame 71. As seen in FIG. 7, the respective air plenums each include a first end 331 and an opposite second end 332. The first end 331 is substantially aligned with the air passageway 83 that is formed in the front or forward facing wall 73. As further seen in FIG. 8, an air passageway 333 is formed from or defined by a plurality of apertures in the rearward facing wall 74. This air passageway 333 is substantially aligned with each of the air plenums 330. As seen in FIG. 7, individual cooling assemblies or fans 340 are placed intermediate, the opposite first and second ends 331 and 332 of each of the air plenums 330. Each cooling assembly 340 is electrically coupled to the electronic control assembly 320 and is selectively controlled thereby. As will be recognized, in this construction, heat energy generated by the fuel cell stack 301 is conducted away from the fuel cell stack 301 by the action of the respective heat sinks or heat exchangers 310. The respective heat exchangers, which are individually disposed in each of the air plenums 330 release the heat energy generated by the fuel cell stack 301 to the ambient air which is moving or flowing between the first and second ends of the air plenums by way of the energized fan assemblies 340. In this way, heat energy generated by the fuel cell stack 301 is removed from same and exhausted to ambient. The electronic control assembly 320 is operable to energize and de-energize the fan assembly in order to maintain the fuel cell stack within a given operable temperature range.

### OPERATION

The operation of the described embodiments of the present invention are believed to be readily apparent and are briefly summarized at this point.

A fuel cell power system 10 of the present invention is generally indicated by the numeral 10 and is shown in FIGS. 1, 2 and 3 respectively. The fuel cell power system includes a plurality of fuel cell power modules 70, 200, 300 each enclosing a fuel cell stack 110, 201, 301, and a cooling assembly 140, 230, 340; and wherein at least one of the modules 70, 200, 300 can be removed from the fuel cell power system, by hand, while the remaining modules continue to operate.

Still further, the fuel cell power system 10 of the present invention includes an enclosure 11 defining an internal space or cavity 20. A fuel cell module subrack 50 is moveably mounted on the enclosure and operable to be received in the internal space or cavity of the enclosure. A plurality of fuel cell modules 70, 200, 300 each including a fuel cell stack 110, 201, 301, operably mate with the subrack 50, and can be removed from the subrack 50 while the remaining fuel cell modules continue to operate.

In addition to the foregoing, a fuel cell power module 70, 200, 300 is disclosed and which includes a module frame 71 having an internal cavity 72. The module frame 71 receives a fuel cell stack 110, 201, 301 mounted in the internal cavity of the module frame. A controller 150, 250, 320 is electrically coupled to the fuel cell stack. A cooling assembly including such structures as 140, 230, 340 are provided and are further electrically coupled with the controller for dissipating heat energy generated by the fuel cell stack while it is operational.

The fuel cell power system 10 as disclosed in the first/70, second/200 and third/300 forms of the invention includes a subrack 50 within which a D.C. electrical bus 67; a fuel/air or oxidant manifold 68 and a data bus 69 are mounted. The fuel cell power system 10 further includes a module frame 71, defining an internal cavity 72, and which is matingly received and supported in an operable orientation on and in the subrack. An electrical coupler 98 is borne by each module frame 71, and is releasably electrically coupled with the D.C. electrical bus 67 when the module frame 71 is disposed in an operable orientation relative to the subrack 50. A fluid coupler 90 is borne by the module frame 71, and releasably couples, in fluid flowing relation relative to the fuel and oxidant manifold 68 when the module frame 71 is disposed in an operable orientation relative to the subrack 50. A fuel cell stack 110, 201 and 301 is mounted in the internal cavity 72 of the module frame 71, and is electrically coupled with both the electrical coupler 98, and the D.C. bus 67, and further is disposed in fluid flowing relation relative to the fuel and oxidant manifold 68 when the module frame 71 is disposed in an operable orientation relative to the subrack 50. As noted above, the fuel cell stack produces heat energy during operation and the fuel cell power system 10 of the present invention includes a cooling assembly such as electric fans, or various heat exchanges or both which are borne by the module frame 50, and which dissipate the heat energy generated by the fuel cell stack during operation. Electronic controls or a controller 150, 250, 320 are provided, and which are electrically coupled with both fuel cell stack and the cooling assembly to control the operation of each. As noted above, this controller optimizes the performance of each of the forms of the present invention, and can be located remotely relative to the respective fuel cell module forms which are disclosed.

As shown in FIG. 1, the fuel cell power system 10 includes multiple subracks 50. Each of the multiple subracks individually support a plurality of fuel cell power modules 70, 200, 300. As will be recognized, the individual subracks can be readily removed from the fuel cell power system 10, by hand, while the remaining fuel cell subracks 51 continue to operate. Likewise, individual fuel cell modules 70, 200, 300 can be removed from their respective subracks 50 for repair or replacement, while the respective subracks 50 continue to operate.

It will be seen, therefore, that the present invention provides many advantages over the prior art devices and practices and avoids the many detriments associated with the use of fuel cell stacks, in a fuel cell power system as shown and described above.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A fuel cell power system, comprising:
a plurality of modules each enclosing a fuel cell stack and a cooling assembly; and wherein at least one of the modules can be removed from the fuel cell power system, by hand, while the remaining modules continue to operate.

2. A fuel cell power system as claimed in claim 1, and further comprising:
a subrack for receiving and supporting each of the modules in an operational orientation, one to the others.

3. A fuel cell power system as claimed in claim 1, and further comprising:
a subrack for receiving and supporting each of the modules in an operational orientation, one to the others;
a D.C. bus borne by the subrack and electrically coupled with the respective modules when the modules are received in an operable position relative to the subrack; and
a fuel and oxidant manifold borne by the subrack and coupled in fluid flowing relation relative to the respective modules when the modules are operably positioned relative to the subrack.

4. A fuel cell power system as claimed in claim 1, wherein each of the modules further comprise:
a module frame, defining an internal cavity, and wherein the fuel cell stack and cooling assembly are received in the internal cavity of the module frame.

5. A fuel cell power system as claimed in claim 1, and further comprising:
a subrack for receiving each of the modules in an operational orientation, one to the others;
a D.C. bus borne by the subrack and electrically coupled with the respective modules when the modules are positioned in an operable orientation relative to the subrack;
a fuel and oxidant manifold borne by the subrack and coupled in fluid flowing relation relative to the respective modules when the modules are positioned in an operable orientation relative to the subrack, and wherein each of the modules comprise a module frame which matingly cooperates with the subrack, and which further defines an internal cavity; and wherein the fuel cell stack and cooling assembly are received in the internal cavity and the fuel cell stack is electrically coupled to the D.C. bus, and disposed in fluid flowing relationship relative to the fuel and oxidant manifold, when the respective modules are positioned in an operational orientation relative to the subrack.

6. A fuel cell power system as claimed in claim 3, wherein each of the modules further comprise:
a module frame, defining an internal cavity;
an electrical coupler borne by the module frame and which is operable to releasably electrically couple with the D.C. bus when the module frame is disposed in an operable orientation relative to the subrack;
a fluid coupler borne by the module frame and which is operable to releasably couple in fluid flowing relationship with the fuel and oxidant manifold when the module frame is disposed in an operable orientation relative to the subrack; and wherein the fuel cell stack is mounted in the internal cavity of the module frame and electrically coupled with the electrical coupler, and the D.C. bus, and further is disposed in fluid flowing relation relative to the fuel and oxidant manifold when the module frame is disposed in an operable orientation relative to the subrack.

7. A fuel cell power system as claimed in claim 6, wherein the fuel cell stack produces heat energy during operation and which collects in the internal cavity of the module frame, and wherein the cooling assembly comprises a fan mounted on the module frame and which facilitates the dissipation of the heat energy from the internal cavity.

8. A fuel cell power system as claimed in claim 7, wherein the fan exhausts the heat energy from the internal cavity of the module frame to an ambient environment.

9. A fuel cell power system as claimed in claim 7, wherein the cooling assembly further comprises:
an air plenum which is positioned in the internal cavity of the module frame, and wherein the fan moves a source of ambient air along same.

10. A fuel cell power system as claimed in claim 9, wherein the cooling assembly further comprises:
a heat exchanger which is borne by the fuel cell stack and which is operable to conduct heat energy away from the fuel cell stack, and wherein the heat exchanger is disposed in heat transferring relation relative to the air plenum.

11. A fuel cell power system as claimed in claim 9, and wherein the cooling assembly further comprises:
a coolant pump mounted in the internal cavity of the module frame and which is coupled in fluid flowing relation relative to the fuel cell stack, the coolant pump circulating a source of coolant through the fuel cell stack to remove heat energy generated by the fuel cell stack during operation; and
a heat exchanger coupled in heat exchanging relation relative to the coolant pump, the heat exchanger disposed in heat transferring relation relative to the air plenum.

12. A fuel cell power system as claimed in 3, wherein each of the modules further comprise:
a module frame, defining an internal cavity;
an electrical coupler borne by the module frame and which releasably electrically couples with the D.C. bus when the module frame is disposed in an operable orientation relative to the subrack;
a fluid coupler borne by the module frame and which releasably couples in fluid flowing relationship with the fuel and oxidant manifold when the module frame is disposed in an operable orientation relative to the subrack; and wherein the fuel cell stack is mounted in the internal cavity of the module frame and is further electrically coupled with both the electrical coupler and the D.C. bus, and disposed in fluid flowing relation relative to the fuel and oxidant manifold when the module frame is disposed in an operable orientation relative to the subrack, and wherein the fuel cell stack produces heat energy during operation; and wherein the cooling assembly is borne by the module frame and dissipates the heat energy generated by the fuel cell stack during operation; and
a controller which is electrically coupled with both the fuel cell stack and the cooling assembly to control the operation of each.

13. A fuel cell power system as claimed in claim 12, wherein the cooling assembly further comprises:
an air plenum borne by the module frame and mounted in the internal cavity thereof, and which directs a source of ambient air through the internal cavity of the module frame; and
a fan assembly borne by the module frame and which moves the ambient air along the air plenum to dissipate the heat energy generated by the fuel cell stack during operation and which is present in the internal cavity of the module frame.

14. A fuel cell power system as claimed in claim 13, wherein the cooling assembly further comprises:
a heat exchanger which is borne by the fuel cell stack and which conducts heat energy away from the fuel cell stack while it is in operation, and wherein the heat exchanger is disposed in heat transferring relation relative to the air plenum.

15. A fuel cell power system as claimed in claim 13, and wherein the cooling assembly further comprises:
a coolant pump mounted in the internal cavity of the module frame and which is coupled in fluid flowing relation relative to the fuel cell stack, and which circulates a source of coolant through the fuel cell stack to remove heat energy generated by the fuel cell stack; and
a heat exchanger coupled in heat exchanging relation relative to the coolant pump, and disposed in heat transferring relation relative to the air plenum.

16. A fuel cell power system, comprising:
an enclosure defining an internal space;
a subrack movably mounted on the enclosure and operable to be received in the internal space of the enclosure; and
a plurality of modules, each enclosing a fuel cell stack and a cooling assembly, and wherein the modules operably mate with the subrack, and can be removed from the subrack while the remaining modules continue to operate.

17. A fuel cell power system as claimed in claim 16, and which further comprises multiple subracks which are each movably and releasably mounted on the enclosure and are individually received in the internal space of the enclosure, and wherein individual subracks can be removed from the enclosure while the remaining subracks remain operational.

18. A fuel cell power system as claimed in claim 16, wherein the enclosure further comprises:
an electrical conduit coupled to the subrack;
a fuel and oxidant conduit each coupled in fluid flowing relation relative to the subrack; and
a controller conduit coupled in signal transmitting and receiving relation relative to the subrack.

19. A fuel cell power system as claimed 18, and which further comprises multiple subracks which are each movably and releasably mounted on the enclosure and are individually received in the internal space of the enclosure, and wherein individual subracks can be removed from the enclosure, by hand, while the remaining subracks remain operational, and wherein each subrack is releasably coupled to each of the electrical conduit, fuel and oxidant conduit, and controller conduit.

20. A fuel cell power system as claimed in claim 17, wherein each subrack further comprises:
a D.C. bus borne by the subrack and electrically coupled with the respective modules when each of the modules are received in an operable position relative to the subrack; and
a fuel and oxidant manifold borne by the subrack and coupled in fluid flowing relation relative to the respective modules when the respective modules are operably positioned relative to the subrack.

21. A fuel cell power system as claimed in claim 18, wherein each of the modules further comprise:
a module frame which defines an internal cavity; and wherein the fuel cell stack and the cooling assembly are received in the internal cavity of the module frame, and wherein the respective module frames matingly cooperate with the subrack, and wherein each module frame is both electrically coupled to the D.C. bus, and disposed in fluid flowing relationship relative to the fuel and oxidant manifold, when the respective modules are positioned in an operational orientation relative to the subrack.

22. A fuel cell power system as claimed in claim 21, wherein each of the module frames further comprise:
an electrical coupler borne by the respective module frames and which is operable to releasably electrically couple with the D.C. bus when each of the module frames are disposed in an operable orientation relative to the subrack; and
a fluid coupler borne by the respective module frames and which is operable to releasably couple in fluid flowing relationship with the fuel and oxidant manifold when the module frame is disposed in an operable orientation relative to the subrack.

23. A fuel cell power system as claimed in claim 22, wherein the fuel cell stack produces heat energy during operation and which collects in the internal cavity of the module frame, and wherein the cooling assembly comprises a fan which is mounted on the module frame and which facilitates the dissipation of the heat energy from the internal cavity.

24. A fuel cell power system as claimed in claim 22, wherein the cooling assembly further comprises:
an air plenum which is positioned in the internal cavity of the module frame, and wherein the fan moves a source of ambient air along same.

25. A fuel cell power system as claimed in claim 24, wherein the cooling assembly further comprises:
a heat exchanger which is borne by the fuel stack and which is operable to conduct heat energy away from the fuel cell stack, and wherein the heat exchanger is disposed in heat transferring relation relative to the air plenum.

26. A fuel cell power system as claimed in claim 24, and wherein the cooling assembly further comprises:
a coolant pump mounted in the internal cavity of the module frame and which is coupled in fluid flowing relation relative to the fuel cell stack, and which circulates a source of coolant through the fuel cell stack to remove heat energy generated by the fuel cell stack; and
a heat exchanger coupled in heat exchanging relation relative to the coolant pump, and which is disposed in heat transferring relation relative to the air plenum.

27. A fuel cell power system as claimed in claim 23, wherein each of the modules further comprise:
a controller which is electrically coupled with both the fuel cell stack and the cooling assembly to control the operation of each.

28. A fuel cell power module, comprising:
a module frame having an internal cavity;
a fuel cell stack mounted in the internal cavity of the module frame;
a controller which is electrically coupled to the fuel cell stack; and
a cooling assembly borne by the module frame and which is electrically coupled with the controller for dissipating heat energy generated while the fuel cell stack is operational.

29. A fuel cell power module as claimed in claim 28, wherein the module frame is defined by an exterior wall, and further has opposite first and second ends, and wherein a control panel is borne by the first end of the exterior wall and is electrically coupled with the controller; and wherein the controller is mounted in the internal cavity of the module frame.

30. A fuel cell power module as claimed in claim 29, wherein an electrical coupler is mounted on the exterior wall at the second end of the module frame and further electrically coupled to the fuel cell stack, and wherein a fluid coupler for delivering a fuel supply and an oxidant supply to the fuel cell stack is mounted on the second end of the module frame and is coupled in fluid flowing relation relative to the fuel cell stack, and wherein a data coupler is mounted on the second end of the module frame and is electrically coupled with the controller.

31. A fuel cell power module as claimed in claim 30, wherein the cooling assembly further comprises:
a fan mounted on the first end of the module frame and which exhausts heat which has collected in the internal cavity of the module frame to ambient.

32. A fuel cell power module as claimed in claim 30, wherein the cooling assembly further comprises:
an air plenum borne by, and which extends between, the first and second ends of the module frame, and which further is coupled in fluid flowing relation to ambient; and
a fan mounted in the internal cavity of the module frame and coupled to the air plenum to facilitate the movement of ambient air between the opposite ends of the module frame.

33. A fuel cell power module as claimed in claim 32, wherein the cooling assembly further comprises:
a heat exchanger mounted on the fuel cell stack, and which conducts heat energy away from fuel cell stack during operation, and wherein at least a portion of the heat exchanger is located within the air plenum.

34. A fuel cell power module as claimed in claim 32, wherein the cooling assembly further comprises:
a coolant pump for circulation of a coolant and which is coupled in fluid flowing relation relative to the fuel cell stack; and
a heat exchanger mounted on the module frame, and wherein a portion of the heat exchanger is located within the air plenum, and is further coupled in heat exchanging relation relative to the coolant pump.

35. A fuel cell power module as claimed in claim 31, wherein the fuel cell module frame matingly couples with a subrack which supports the fuel cell module in an operable orientation.

37. A fuel cell power module as claimed in claim 35, wherein the subrack further comprises:
a D.C. bus borne by the subrack and electrically coupled with the fuel cell power module, by way of the electrical coupler, when the fuel cell power module is received in an operable position relative to the subrack; and
a fuel and oxidant manifold borne by the subrack and coupled in fluid flowing relation relative to the fuel cell power module when the module is operably positioned relative to the subrack.

38. A fuel cell power module as claimed in claim 37, wherein the subrack supporting the fuel cell module holds a plurality of fuel cell modules to form a fuel cell power system, and wherein the respective fuel cell modules may be removed from the subrack while the remaining fuel cell modules continue to operate.

39. A fuel cell power module as claimed in claim 38, and further comprising:
an enclosure having a cavity and which matingly and operably receives the subrack, and wherein the enclosure mounts multiple subracks, and wherein individual subracks may be removed from the enclosure while the remaining subracks remain operational.

40. A fuel cell power system, comprising:
a subrack;
a D.C. bus mounted on the subrack;
a fuel and oxidant manifold borne by the subrack;
a module frame, defining an internal cavity and which is matingly received and supported in an operable orientation on the subrack;
an electrical coupler borne by the module frame and which releasably electrically couples with the D.C. bus when the module frame is disposed in an operable orientation relative to the subrack;
a fluid coupler borne by the module frame and which releasably couples in fluid flowing relationship with the fuel and oxidant manifold when the module frame is disposed in an operable orientation relative to the subrack;
a fuel cell stack mounted in the internal cavity of the module frame and which is electrically coupled with both the electrical coupler and the D.C. bus, and further disposed in fluid flowing relation relative to the fuel and oxidant manifold when the module frame is disposed in an operable orientation relative to the subrack, and wherein the fuel cell stack produces heat energy during operation;
a cooling assembly borne by the module frame and which dissipates the heat energy generated by the fuel cell stack during operation; and
a controller which is electrically coupled with both the fuel cell stack and the cooling assembly to control the operation of each.

41. A fuel cell power system as claimed in claim 40, wherein the cooling assembly further comprises:
an air plenum borne by the module frame, and which further is coupled in fluid flowing relation to ambient; and
a fan mounted in the internal cavity of the module frame and coupled to the air plenum to facilitate the movement of ambient air along the air plenum.

42. A fuel cell power system as claimed in claim 41, wherein the cooling assembly further comprises:
a heat exchanger mounted on the fuel cell stack and which conducts heat energy away from fuel cell stack during operation, and wherein at least a portion of the heat exchanger is located within the air plenum.

43. A fuel cell power system as claimed in claim 41, wherein the cooling assembly further comprises:
a coolant pump for circulation of a coolant coupled in fluid flowing relation relative to the fuel cell stack; and
a heat exchanger mounted in the module frame, and wherein a portion of the heat exchanger is located within the air plenum, and is further coupled in heat exchanging relation relative to the coolant pump.

44. A fuel cell power system as claimed in claim 40, wherein the subrack supporting the fuel cell module supports a plurality of fuel cell modules, and wherein the respective fuel cell modules may be removed from the subrack while the remaining fuel cell modules continue to operate.

45. A fuel cell power system as claimed in claim 40, and further comprising:
an enclosure defining a cavity and which matingly and operably receives and supports the subrack, and wherein the enclosure releasably mounts multiple subracks, and wherein individual subracks can be removed from the enclosure while the remaining subracks remain operational.

46. A fuel cell power system, comprising:
an enclosure having a cavity and which has a data conduit; a power conduit; and a fuel delivery conduit mounted on same;
multiple subracks releasably borne by the enclosure and supported in an operable orientation in the cavity;
a D.C. bus mounted on each of the subracks and which is electrically coupled to the power conduit when the respective subracks are received in the cavity of the enclosure;
a fuel manifold mounted on each of the subracks and which is coupled in fluid flowing relation relative to the fuel delivery conduit when the respective subracks are received in the cavity of the enclosure;
multiple fuel cell modules operably received and supported by the respective subracks, and wherein each of the fuel cell modules have a module frame, defining an internal cavity, and which is matingly received and supported in an operable orientation on the respective subracks;
an electrical coupler borne by each of the module frames and which releasably electrically couples with the D.C. bus when the individual module frames are disposed in an operable orientation relative to one of the subracks;
a fluid coupler mounted on each of the module frames and which releasably couples in fluid flowing relationship with the fuel manifold when the module frame is disposed in an operable orientation relative to one of the subracks;
a fuel cell stack mounted in the internal cavity of each of the module frames and which is electrically coupled with both the electrical coupler and the D.C. bus, and further disposed in fluid flowing relation relative to the fuel manifold when the module frame is disposed in an operable orientation relative to one of the subracks, and wherein each fuel cell stack produces heat energy during operation;
a cooling assembly borne by each of the module frames and which dissipates the heat energy generated by each of the fuel cell stacks during operation; and
a controller which is electrically coupled with both the fuel cell stack and the cooling assembly of that fuel cell module to control the operation of each, and wherein the controller is coupled in signal transmitting and receiving relation relative to the data conduit, and wherein individual subracks and individual fuel cell modules may be operably removed from the fuel cell power system while the remaining fuel cell modules and subracks remain operational.
